(19) United States
(12) Patent Application Publication
(10) Pub. No.: US 2020/0384770 A1
(43) Pub. Date: Dec. 10, 2020

(54) Liquid Discharge Head

(71) Applicant: Brother Kogyo Kabushiki Kaisha, Nagoya-shi (JP)

(72) Inventor: Keita Sugiura, Toyokawa-shi (JP)

(21) Appl. No.: 16/878,052

(22) Filed: May 19, 2020

(30) Foreign Application Priority Data
Jun. 5, 2019 (JP) 2019-105537

(51) Int. Cl. B41J 2/14

(52) U.S. Cl. CPC B41J 2/14233; B41J 2002/14306

(57) ABSTRACT

A liquid discharge head includes: individual channels arranged in a first direction; and first and second common channels each extending in the first direction. An opening of the first common channel and an opening of the second common channel are arranged at the same side with respect to the individual channels in the first direction. Each of the individual channels includes: a first communicating channel and a second communicating channel communicating with the first common channel, and a third communicating channel communicating with the second common channel. A midpoint in the first direction between a first connection position where the first common channel is connected to the first communicating channel and a second connection position where the first common channel is connected to the second communicating channel is positioned in a range of a third connection position where the second common channel is connected to the third communicating channel

### CROSS REFERENCE TO RELATED APPLICATION

The present application claims priority from Japanese Patent Application No. 2019-105537 filed on Jun. 5, 2019, the disclosure of which is incorporated herein by reference in its entirety.

### BACKGROUND

### Field of the Invention

The present disclosure relates to a liquid discharge head including common channels.

### Description of the Related Art

There is known a liquid discharge head including individual channels. In this liquid discharge head, each individual channel includes two circulation individual channels (first communicating channel and second communicating channel) communicating with a circulation common channel (first common channel), and an individual supply channel (third communicating channel) communicating with an ink supply channel (second common channel).

### SUMMARY

In the liquid discharge head, an opening of the circulation common channel and an opening of the ink supply channel may be positioned at the same side with respect to the individual channels in a nozzle arrangement direction, and a midpoint in the nozzle arrangement direction between a position where the circulation common channel is connected to one of the two circulation individual channels and a position where the circulation common channel is connected to the other of the two circulation individual channels may not be positioned in a range of a position where the ink supply channel is connected to the individual supply channel In this case, a pressure balance in the individual channels is lost owing to the difference in pressures acting on the respective connection positions, which may cause excessive pressure acting on the nozzles during ink (liquid) circulation and fluctuation in ink discharge from the nozzles.

An object of the present disclosure is to provide a liquid discharge head capable of inhibiting excessive pressure that may otherwise act on nozzles during liquid circulation.

According to an aspect of the present disclosure, there is provided a liquid discharge head, including: a plurality of individual channels arranged in a first direction; and a first common channel and a second common channel extending in the first direction, wherein an opening of the first common channel and an opening of the second common channel are arranged at the same side with respect to the individual channels in the first direction, each of the individual channels includes: a first communicating channel and a second communicating channel communicating with the first common channel; and a third communicating channel communicating with the second common channel, and a midpoint in the first direction between a first connection position where the first common channel is connected to the first communicating channel and a second connection position where the first common channel is connected to the second communicating channel is positioned in a range of a third connection position where the second common channel is connected to the third communicating channel

### BRIEF DESCRIPTION OF THE DRAWINGS

FIG. 1 is a plan view of a printer including heads according to the first embodiment of the present disclosure.

FIG. 2 is a plan view of the head.

FIG. 3 is a cross-sectional view taken along a line in FIG. 2.

FIG. 4 is a perspective view depicting part of channels formed in the head.

FIG. 5 is a plan view of a head according to the second embodiment of the present disclosure.

FIG. 6 is a plan view of a head according to the third embodiment of the present disclosure.

FIG. 7 is a cross-sectional view taken along a line VII-VII in FIG. 6.

FIG. 8 is a plan view of a head according to the fourth embodiment of the present disclosure.

### DESCRIPTION OF THE EMBODIMENTS

### First Embodiment

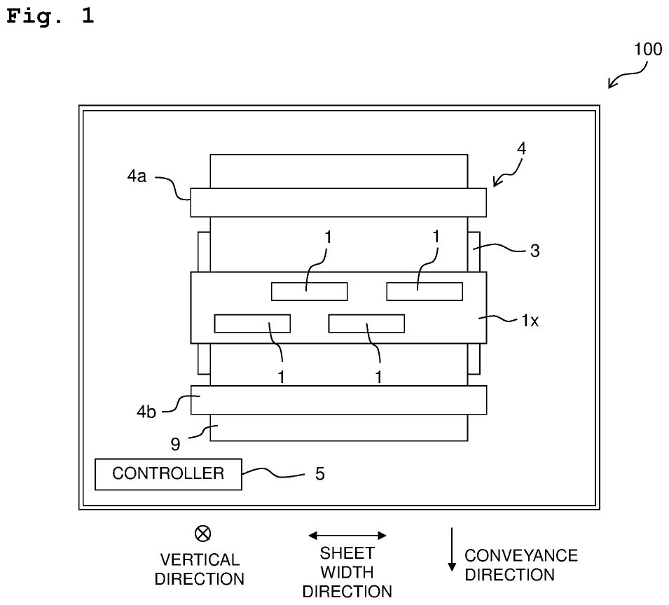

Referring to FIG. 1, a schematic configuration of a printer 100 including heads 1 according to the first embodiment of the present disclosure is explained.

The printer 100 includes a head unit 1x including four heads 1, a platen 3, a conveyer 4, and a controller 5.

A sheet P is placed on an upper surface of the platen 3.

The conveyer 4 has two roller pairs 4a and 4b disposed to interpose the platen 3 therebetween in a conveyance direction. When a conveyance motor (not depicted) is driven by the control of the controller 5, the roller pairs 4a and 4b nipping the sheet 9 rotate and the sheet P is conveyed in the conveyance direction.

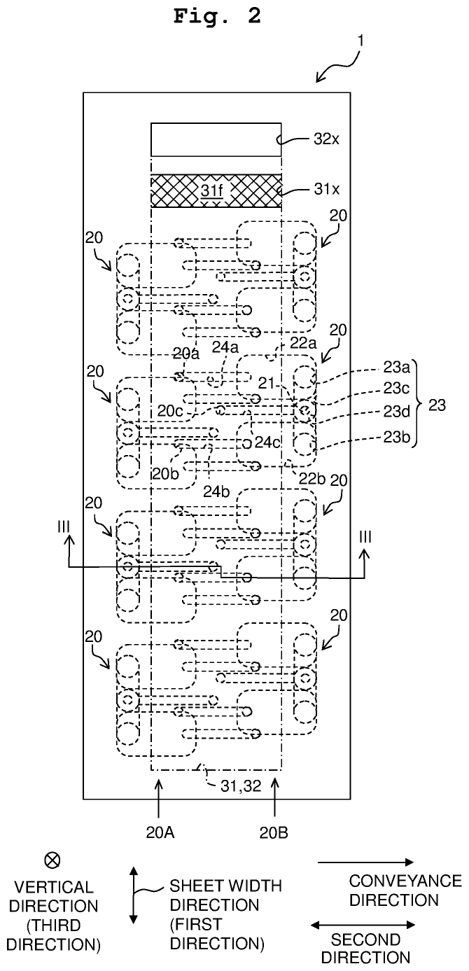

The head unit 1x is long in a sheet width direction (direction orthogonal to the conveyance direction and a vertical direction). The head unit 1x is a line-type head unit in which ink is discharged from nozzles 21 (see FIGS. 2 to 4) on the sheet 9 with the head unit 1x being fixed or secured to a body of the printer 100. The four heads 1, which are long in the sheet width direction, are arranged zigzag in the sheet width direction.

The controller 5 includes a Read Only Memory (ROM), a Random Access Memory (RAM), and an Application Specific Integrated Circuit (ASIC). The ASIC executes recording processing and the like in accordance with programs stored in the ROM. In the recording processing, the controller 5 controls a driver IC (not depicted) and the conveyance motor (not depicted) of each head 1 based on a recording instruction (including image data) input from an external apparatus, such as a PC, to record an image on the sheet 9.

Referring to FIGS. 2 to 4, a configuration of the head 1 is explained.

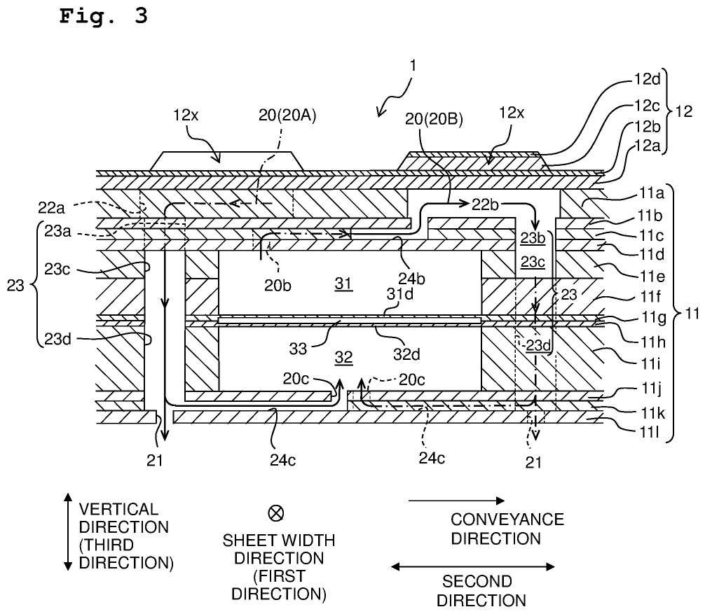

As depicted in FIG. 3, the head 1 includes a channel substrate 11 and an actuator substrate 12.

The channel substrate 11 includes twelve plates 11a to 11l that are stacked on top of each other in the vertical direction. The plates 11a to 11l are adhered to each other. The plates 11a to 11l are formed having through holes forming channels. The channels include individual channels 20, a supply channel 31, and a return channel 32.

As depicted in FIG. 2, the individual channels 20 are arranged zigzag in the sheet width direction (first direction) to form a first individual channel group 20A and a second individual channel group 20B. Each of the individual channel groups 20A and 20B is formed by the individual channels 20 arranged in the first direction. The first individual channel group 20A and the second individual channel group 20B are arranged in a direction parallel to the conveyance direction (second direction: a width direction of the supply channel 31 and the return channel 32, and a direction orthogonal to the first direction).

The supply channel 31 and the return channel 32 extend in the first direction. The supply channel 31 corresponds to a “first common channel” of the present disclosure. The return channel 32 corresponds to a “second common channel” of the present disclosure. In this embodiment, the supply channel 31 and the return channel 32 are arranged in the vertical direction (third direction: a height direction of the supply channel 31 and the return channel 32, a direction orthogonal to the first direction and the second direction). The supply channel 31 overlaps in the vertical direction with the return channel 32. The supply channel 31 and the return channel 32 have substantially the same length (length in the first direction), substantially the same width (length in the second direction), and substantially the same height (length in the third direction).

One end in the first direction (lower end in FIG. 2) of the supply channel 31 is coupled to one end in the first direction (lower end in FIG. 2) of the return channel 32.

The supply channel 31 communicates with a subtank (not depicted) via a supply opening 31x provided in the other end in the first direction (upper end in FIG. 2). The return channel 32 communicates with the subtank (not depicted) via a return opening 32x provided in the other end in the first direction (upper end in FIG. 2). The supply opening 31x corresponds to an “opening of the first common channel” of the present disclosure. The return opening 32x corresponds to an “opening of the second common channel” of the present disclosure.

The supply opening 31x and the return opening 32x are positioned on the same side with respect to the individual channels 20 in the first direction. The supply opening 31x and the return opening 32x are arranged in the first direction. The supply opening 31x is positioned between the individual channels 20 and the return opening 32x in the first direction. Namely, an interval in the first direction between the return opening 32x and the individual channels 20 is larger than an interval in the first direction between the supply opening 31x and the individual channels 20.

The supply opening 31x and the return opening 32x are opened in an upper surface of the channel substrate 11. The supply opening 31x is formed having a filter 31f, and the return opening 32x is formed having no filter.

The subtank communicates with a main tank containing ink, and the subtank contains ink supplied from the main tank. Driving a pump (not depicted) through the control by the controller 5 supplies ink in the subtank into the supply channel 31 through the supply opening 31x. The ink flowing into the supply channel 31 is supplied to the individual channels 20 while moving through the supply channel 31 from the other end in the first direction (upper end in FIG. 2) toward the one end in the first direction (lower end in FIG. 2). The ink reaching the one end in the first direction (lower end in FIG. 2) of the supply channel 31 and the ink flowing out of the individual channels 20 flow into the return channel 32. The ink flowing into the return channel 32 moves through the return channel 32 from the one end (lower end in FIG. 2) toward the other end (upper end in FIG. 2) in the first direction, and returns to the subtank via the return opening 32x.

As depicted in FIG. 3, the supply channel 31 is formed by through holes formed in the plates 11e and 11f. The return channel 32 is formed by a through hole formed in the plate 11i. A damper chamber 33 is provided between the supply channel 31 and the return channel 32 in the third direction. The damper chamber 33 is formed by a recess formed in the plate 11g and a recess formed in the plate 11h. A bottom portion of the recess formed in the plate 11g functions as a dumper film 31d of the supply channel 31. A bottom portion of the recess formed in the plate 11h functions as a dumper film 32d of the return channel 32.

As depicted in FIG. 2, each individual channel 20 includes one nozzle 21, two pressure chambers (first pressure chamber 22a and second pressure chamber 22b), one connection channel 23, two inflow channels (first inflow channel 24a and second inflow channel 24b), and one outflow channel 24c.

As depicted in FIG. 3, the nozzle 21 is formed by a through hole formed in the plate 11l. The nozzle 21 is opened in a lower surface of the channel substrate 11. The first pressure chamber 22a and the second pressure chamber 22b are formed by through holes formed in the plate 11a. The first pressure chamber 22a and the second pressure chamber 22b are opened in the upper surface of the channel substrate 11.

As depicted in FIG. 2, the first pressure chamber 22a and the second pressure chamber 22b have the same shape and dimension. The first pressure chamber 22a and the second pressure chamber 22b are arranged in the first direction. In a plane parallel to the first direction and the second direction (plane orthogonal to the third direction), each of the pressure chambers 22a and 22b has a substantially rectangular shape that is long in the second direction. One end in the second direction of the first pressure chamber 22a is connected to the connection channel 23, and the other end in the second direction of the first pressure chamber 22a is connected to the first inflow channel 24a. One end in the second direction of the second pressure chamber 22b is connected to the connection channel 23, and the other end in the second direction of the second pressure chamber 22b is connected to the second inflow channel 24b.

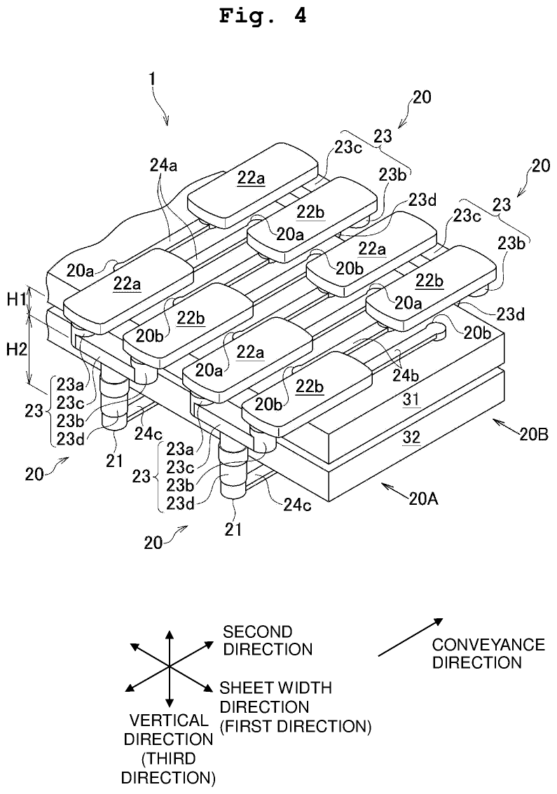

The connection channel 23 connects the nozzle 21 and the first pressure chamber 22a, and connects the nozzle 21 and the second pressure chamber 22b. Specifically, as depicted in FIG. 4, the connection channel 23 includes a first connection portion 23a connected to the first pressure chamber 22a, a second connection portion 23b connected to the second pressure chamber 22b, a coupling portion 23c coupling the first connection portion 23a with the second connection portion 23b, and an extending portion 23d extending downward from the coupling portion 23c and having the nozzle 21 at a lower end thereof.

In this embodiment, each of the connection portions 23a and 23b is a cylindrical channel extending downward from the one end in the second direction of each of the pressure chambers 22a and 22b. As depicted in FIG. 3, each of the connection portions 23a and 23b is formed by through holes formed in the plates 11b to 11d. The present disclosure, however, is not limited thereto. For example, the coupling portion 23c may be positioned immediately under the pressure chambers 22a and 22b (i e , channels, such as the cylindrical channels, are not positioned between the coupling portion 23c and the pressure chambers 22a, 22b), and each of the connection portions 23a and 23b may be formed by an interference between each of the pressure chambers 22a, 22b and the coupling portion 23c (an opening formed in a lower surface of each of the pressure chambers 22a and 22b).

As depicted in FIG. 3, the coupling portion 23c is formed by the through hole formed in the plate 11e. The coupling portion 23c extends in the first direction along a plane orthogonal to the third direction.

As depicted in FIG. 3, the extending portion 23d is formed by through holes formed in the plates 11f to 11k. The extending portion 23d extends in the third direction. The nozzle 21 is positioned on the lower side of the coupling portion 23c (at the opposite side of the first pressure chamber 22a and the second pressure chamber 22b) in the third direction.

In this embodiment, as depicted in FIG. 4, a length H1 in the third direction ranging from the first pressure chamber 22a and the second pressure chamber 22b to the coupling portion 23c is less than a length H2 in the third direction ranging from the coupling portion 23c to the nozzle 21. Namely, the coupling portion 23c is positioned in an upper portion of an area occupied by the connection channel 23 (a side close to the pressure chambers 22a and 22b).

As depicted in FIG. 2, each of the pressure chambers 22a and 22b belonging to the first individual channel group 20A includes a portion overlapping in the third direction with the supply channel 31 and the return channel 32, and a portion not overlapping in the third direction with the supply channel 31 and the return channel 32 and positioned at one side in the second direction with respect to the supply channel 31 and the return channel 32. Each of the pressure chambers 22 and 22b belonging to the second individual channel group 20B includes a portion overlapping in the third direction with the supply channel 31 and the return channel 32, and a portion not overlapping in the third direction with the supply channel 31 and the return channel 32 and positioned at the other side in the second direction with respect to the supply channel 31 and the return channel 32.

The connection channels 23 and the nozzles 21 belonging to the first individual channel group 20A are positioned at the one side in the second direction with respect to the supply channel 31 and the return channel 32. The connection channels 23 and the nozzles 21 belonging to the second individual channel group 20B are positioned at the other side in the second direction with respect to the supply channel 31 and the return channel 32.

Each first inflow channel 24a has one end connected to the other end in the second direction of the first pressure chamber 22a (an opposite end of the one end connected to the connection channel 23) and the other end connected to the supply channel 31 (inlet 20a of the individual channel 20). Each second inflow channel 24b has one end connected to the other end in the second direction of the second pressure chamber 22b (an opposite end of the one end connected to the connection channel 23) and the other end connected to the supply channel 31 (inlet 20b of the individual channel 20). The supply channel 31 communicates with the first pressure chamber 22a and the second pressure chamber 22b via the first inflow channel 24a and the second inflow channel 24b, respectively.

As depicted in FIG. 3, each of the inflow channels 24a and 24b is formed by through holes formed in the plates 11b to 11d.

As depicted in FIG. 3, the outflow channel 24c is formed by through holes formed in the plates 11j and 11k. The outflow channel 24c has one end connected to a lower end of the extending portion 23d and the other end connected to the return channel 32 (outlet 20c of the individual channel 20). The return channel 32 communicates with the connection channel 23 via the outflow channel 24c.

Each of the inflow channels 24a, 24b and the outflow channel 24c has a width smaller than a width (length in the first direction) of each of the pressure chambers 22a and 22b. Each of the inflow channels 24a, 24b and the outflow channel 24c functions as a throttle.

The first inflow channel 24a corresponds to a “first communicating channel” of the present disclosure, the second inflow channel 24b corresponds to a “second communicating channel” of the present disclosure, and the outflow channel 24c corresponds to a “third communicating channel” of the present disclosure. The inlet 20a is a connection opening that connects the supply channel 31 and the first inflow channel 24a, and a position of the inlet 20a corresponds to a “first connection position” of the present disclosure. The inlet 20b is a connection opening that connects the supply channel 31 and the second inflow channel 24b, and a position of the inflow 20b corresponds to a “second connection position” of the present disclosure. The outlet 20c is a connection opening that connects the return channel 32 and the outflow channel 24c, and a position of the outlet 20c corresponds to a “third connection position” of the present disclosure.

In this embodiment, as depicted in FIG. 2, the inflow channels 24a, 24b and the outflow channel 24c extend in the second direction. The inflow channels 24a, 24b and the outflow channel 24c are arranged in the first direction at regular intervals. The outlet 20c is provided at a center portion between the inlet 20a and the inlet 20b in the first direction. Namely, in the first direction, a midpoint between the position of the inlet 20a (first connection position) and the position of the inlet 20b (second connection position) is in a range of the position of the outlet 20c (third connection position).

The inlets 20a and 20b are positioned between the center portion and one end in the second direction of the supply channel 31. The inlets 20a and 20b are in the same position in the second direction. The outlet 20c is positioned at a center portion in the second direction of the return channel 32. The position in the second direction of the inlet 20c is different from that of the inlets 20a and 20b.

The inlets 20a and 20b are provided in an upper surface of the supply channel 31 (see FIG. 3). The inlets 20a and 20b are in the same position in the third direction. The outlet 20c is provided in a lower surface of the return channel 32. The outlet 20c is positioned below the inlets 20a and 20b.

The ink supplied from the supply channel 31 to each individual channel 20 passes through the first inflow channel 24a and the second inflow channel 24b and flows into the first pressure chamber 22a and the second pressure chamber 22b, respectively. Then, the ink moves through the respective pressure chambers 22a and 22b substantially horizontally and flows into the connection channel 23. The ink flowing into the connection channel 23 passes through the first connection portion 23a and the second connection portion 23b, reaches the coupling portion 23c, and moves downward through the extending portion 23d. Part of the ink is discharged from the nozzle 21, and remaining part of the ink flows into the return channel 32 through the outflow channel 24c.

Circulating ink between the subtank and the channel substrate 11 as described above achieves the discharge of air and inhibits the increase in viscosity of ink not only in the supply channel 31 and the return channel 32 formed in the channel substrate 11 but also in the individual channels 20. When ink contains a settling component (component that may settle, such as pigment), the component is agitated or stirred to inhibit the settling.

As depicted in FIG. 3, the actuator substrate 12 includes a vibration plate 12a, a common electrode 12b, piezoelectric bodies 12c, and individual electrodes 12d in that order from the bottom.

The vibration plate 12a and the common electrode 12b are disposed on the upper surface of the channel substrate 11 (upper surface of the plate 11a). The vibration plate 12a and the common electrode 12b cover all the pressure chambers 22a and 22b formed in the channel substrate 11. The piezoelectric bodies 12c and the individual electrodes 12d are provided for the respective pressure chambers 22a and 22b. The piezoelectric bodies 12c and the individual electrodes 12d overlap in the third direction with the pressure chambers 22a and 22b.

The common electrode 12b and the individual electrodes 12d are electrically connected to the driver IC (not depicted). The driver IC maintains the electrical potential of the common electrode 12b at a ground potential, and changes the electrical potential of the individual electrode 12d. Specifically, the driver IC generates a driving signal based on a control signal from the controller 5 and applies the driving signal to the individual electrode 12d. This changes the electrical potential of the individual electrode 12d between a predefined driving potential and the ground potential. The change in electrical potential of the individual electrode 12d deforms part (actuator 12x) of the vibration plate 12a and the piezoelectric body 12c interposed between the individual electrode 12d and each of the pressure chambers 22a and 22b so that the actuator 12x becomes convex toward each of the pressure chambers 22a and 22b. This changes the volume of each of the pressure chambers 22a and 22b, applies pressure to the ink in each of the pressure chambers 22a and 22b, and thereby discharges ink from the nozzle 21. The actuator substrate 12 includes multiple actuators 12x corresponding to the respective pressure chambers 22a and 22b.

As described above, in this embodiment, the supply channel 31 and the return channel 32 extend in the first direction, and the supply opening 31x and the return opening 32x are provided at the same side in the first direction with respect to the individual channels 20 (see FIG. 2). In this configuration, the pressure in the supply channel 31 may differ from that in the return channel 32 in the first direction (ink flowing direction). In the configuration according to this embodiment, however, pressure can act on the nozzles 21 symmetrically from the supply channel 31 and the return channel 32. In each individual channel 20, the pressure acting on the inlet 20a positioned at an upstream side from the supply channel 31 is larger than the pressure acting on the inlet 20b positioned at a downstream side from the supply channel 31. Thus, the pressure acting on the inlet 20a may be different from that acting on the inlet 20b. In this embodiment, the pressure acting on the outlet 20c (pressure of which positivity and negativity are different from those of the pressure acting on each inlet 20a) cancels or offsets the difference between the pressure acting on the inlet 20a and the pressure acting on the inlet 20b by providing the outlet 20c at the center portion in the first direction between the inlets 20a and 20b (i.e., by positioning the midpoint between the position of the inlet 20a (first connection position) and the position of the inlet 20b (second connection position) in a range of the position of the outlet 20c (third connection position) in the first direction). In this configuration, the balance between the pressure acting on the nozzle 21 from the outlet 20c and the pressure acting on the nozzle 21 from the inlets 20a and 20b is maintained, inhibiting excessive pressure that may otherwise act on the nozzle 21 during ink circulation.

### Second Embodiment

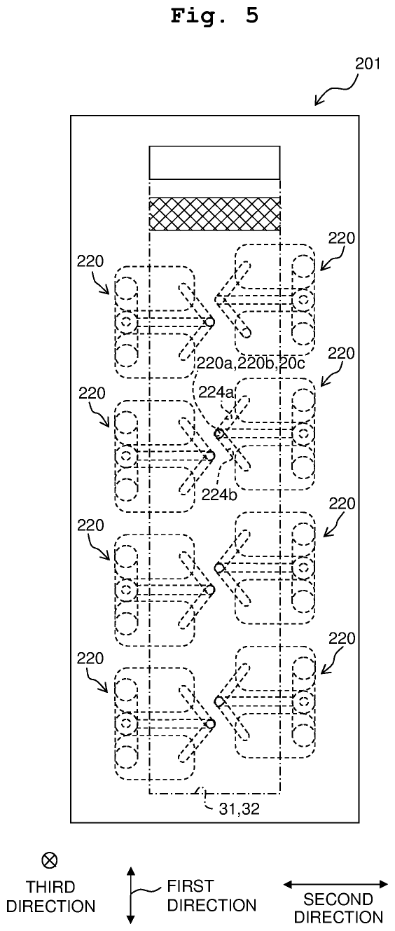

Subsequently, referring to FIG. 5, a head 201 according to the second embodiment of the present disclosure is explained.

In the first embodiment (FIG. 2), the first inflow channel 24a and the second inflow channel 24b of each individual channel 20 extend in the second direction. In this embodiment (FIG. 5), a first inflow channel 224a and a second inflow channel 224b of each individual channel 220 extend in an oblique direction intersecting with the first direction and the second direction.

In the first embodiment (FIG. 2), the inlet 20a and the outlet 20c and the inlet 20b are arranged in the first direction at regular intervals. In this embodiment (FIG. 5), an inlet 220a and an inlet 220b are formed by one opening. The inflow channels 224a and 224b branch off from the one opening and extend in the oblique direction.

The outlet 20c is positioned below the inlets 220 and 220b. The outlet 20c overlaps in the third direction with the inlets 220a and 220b.

The position of the inlet 220a (first connection position) is coincident with the position of the inlet 220b (second connection position) in the first direction, the second direction, and the third direction. The position of the outlet 20c (third connection position) is the coincident with the position of the inlet 220a (first connection position) and the position of the inlet 220b (second connection position) in the first direction and the second direction.

As described above, although the configuration of the inflow channels in the second embodiment is different from that in the first embodiment, the effects similar to the first embodiment can be obtained by satisfying the condition similar to the first embodiment (the condition in which the midpoint between the position of the inlet 220a (first connection position) and the position of the inlet 220b (second connection position) is in a range of the position of the outlet 20c (third connection position) in the first direction).

Further, in this embodiment, the position of the inlet 220a (first connection position) is coincident with the position of the inlet 220b (second connection position) in the first direction (see FIG. 5). When the position of the inlet 220a (first connection position) is not coincident with the position of the inlet 220b (second connection position) in the first direction, the difference in pressure in the first direction in the supply channel 31 may cause the difference between the pressure acting on the inlet 220a and the pressure acting on the inlet 220b. In this case, the flowing of ink different from the desired flowing is caused in the individual channel 220 (e.g., the flowing of ink from the inlet 220a to the inlet 220b is caused), which may make ink discharge unstable. In order to solve this problem, in the second embodiment, the position of the inlet 220a (first connection position) is coincident with the position of the inlet 220b (second connection position) in the first direction. This is thus not likely to cause the difference between the pressure acting on the inlet 220a and the pressure acting on the inlet 220b, making ink discharge stable.

The pressure in the supply channel 31 may differ not only in the first direction but also in the second direction. For example, in the supply channel 31, the flow rate (flow velocity) is likely to be high at a center portion in the second direction (pressure is large), and the flow rate is likely to be low at ends in the second direction (pressure is small). In view of the above, in second embodiment, the position of the inlet 220a (first connection position) is coincident with the position of the inlet 220b (second connection position) not only in the first direction but also in the second direction (see FIG. 5). This configuration reliably inhibits the difference between the pressure acting on the inlet 220a and the pressure acting on the inlet 220b, which makes ink discharge stable.

The pressure in the supply channel 31 may differ not only in the first direction and the second direction but also in the third direction. For example, in the supply channel 31, the flow rate is likely to be high at a center portion in the third direction (pressure is large), and the flow rate is likely to be low at ends in the third direction (pressure is small). In view of the above, in the second embodiment, the position of the inlet 220a (first connection position) is coincident with the position of the inlet 220b (second connection position) not only in the first direction and the second direction but also in the third direction. This configuration reliably inhibits the difference between the pressure acting on the inlet 220a and the pressure acting on the inlet 220b, which makes ink discharge stable. Further, in this configuration, the inlets 220a and 220b can be formed by one opening, resulting in a simple configuration.

Similar to the pressure in the supply channel 31, the pressure in the return channel 32 may differ not only in the first direction but also in the second direction. For example, in the return channel 32, the flow rate is likely to be high at a center portion in the second direction (pressure is large), and the flow rate is likely to be low at ends in the second direction (pressure is small). In view of the above, in the second embodiment, the position of the outlet 20c (third connection position) is coincident with the position of the inlet 220a (first connection position) and the position of the inlet 220b (second connection position) in the second direction (see FIG. 5). In this configuration, the pressure acting on the outlet 20c reliably cancels or offsets the difference between the pressure acting on the inlet 220a and the pressure acting on the inlet 220b, thus maintaining the pressure balance in the individual channel 220.

The wording a certain connection position “is coincident with” another connection position means a situation where the openings forming the respective connection positions at least partially overlap with each other, and thus the openings are not required to overlap with each other completely.

### Third Embodiment

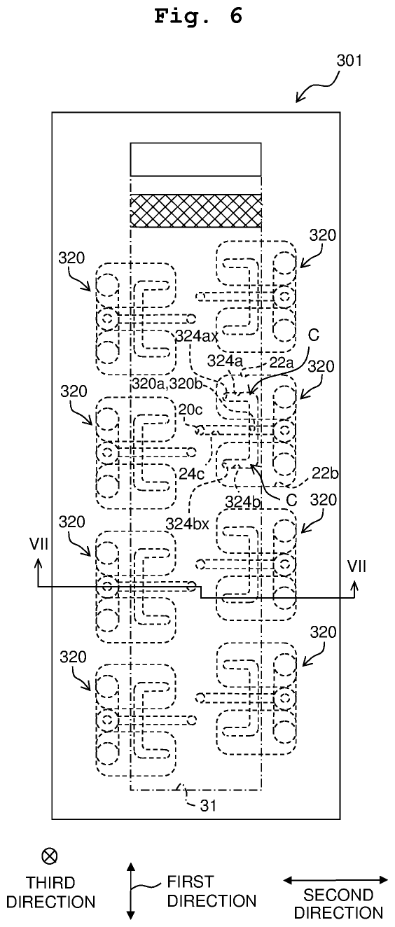

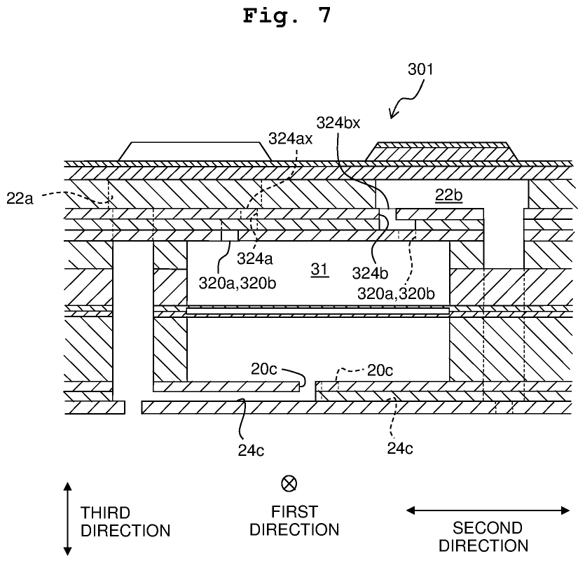

Referring to FIGS. 6 and 7, a head 301 according to the third embodiment of the present disclosure is explained.

In the first embodiment (FIG. 2), the first inflow channel 24a and the second inflow channel 24b of each individual channel 20 extends in the second direction. In this embodiment (FIG. 6), a first inflow channel 324a and a second inflow channel 324b of each individual channel 320 are curved to have a L shape in a plane parallel to the first direction and the second direction (plane orthogonal to the third direction).

In the first embodiment (FIG. 2), the inlet 20a and the outlet 20c and the inlet 20b are arranged in the first direction at regular intervals. In this embodiment (FIG. 6), similar to the inlets 220a and 220b (FIG. 5) of the second embodiment, an inlet 320a and an inlet 320b are formed by one opening. The inflow channels 324a and 324b branch off from the one opening, extend toward one side and the other side in the first direction, and further extends in the second direction.

The first inflow channel 324a has one end 324ax connected to the first pressure chamber 22a and the other end (inlet 320a of the individual channel 320) connected to the supply channel 31. The second inflow channel 324b has one end 324bx connected to the second pressure chamber 22b and the other end (inlet 320b of the individual channel 320) connected to the supply channel 31.

Each of the inflow channels 324a and 324b has a first portion extending from the one end 324ax, 324bx in the second direction and a second portion extending from a front end of the first portion in the first direction to reach the other end (inlet 320a, 320b). A curved portion C is provided between the first portion and the second portion. Each of the inflow channels 324a and 324b corresponds to a “curved channel” of the present disclosure.

The first inflow channel 324a is placed in an area of the first pressure chamber 22a in the second direction. The second inflow channel 324b is placed in an area of the second pressure chamber 22b in the second direction. Namely, the inflow channels 324a and 324b are positioned in the areas of the respective pressure chambers 22a and 22b in the second direction.

As depicted in FIG. 7, the outlet 20c is positioned below the inlets 320a and 320b. The outlet 20c and inlets 320a and 320b are arranged in the second direction as depicted in FIG. 6. The inlets 320a and 320b overlap in the third direction with the outflow channel 24c as depicted in FIG. 7.

As described above, although the configuration of the inflow channels in the third embodiment is different from that in the first direction, the effects similar to the first embodiment can be obtained by satisfying the condition similar to the first embodiment (the condition in which the midpoint between the position of the inlet 320a (first connection position) and the position of the inlet 320b (second connection position) is in a range of the position of the outlet 20c (third connection position) in the first direction).

Further, in this embodiment, the inflow channels 324a and 324b are curved (see FIG. 6), which efficiently increases the resistance of the inflow channels 324a and 324b. The flow rate in the inflow channels 324a and 324b thus increases, which makes the ink supply to each individual channel 320 via the inflow channels 324a and 324b smooth.

The inflow channels 324a and 324b are placed in the areas of the pressure chambers 22a and 22b in the second direction (see FIG. 6). In this case, compared to a case where the inflow channels 324a and 324b are placed outside the areas of the pressure chambers 22a and 22b in the second direction, it is possible to downsize the individual channel 320 in the second direction and to downsize the head 301 in the second direction.

### Fourth Embodiment

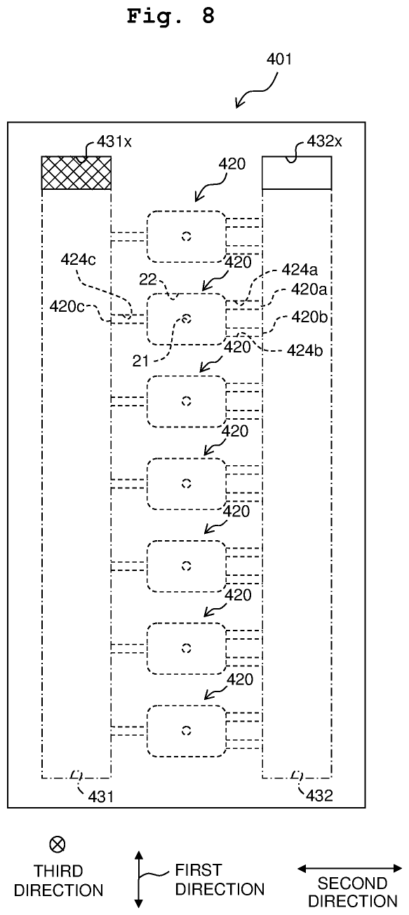

Referring to FIG. 8, a head 401 according to the fourth embodiment of the present disclosure is explained.

In the first embodiment (FIG. 2), the supply channel 31 and the return channel 32 are arranged in the third direction. The one end in the first direction of the supply channel 31 is coupled to the one end in the first direction of the return channel 32. In this embodiment (FIG. 8), a supply channel 431 and a return channel 432 are arranged in the second direction. One end in the first direction of the supply channel 431 is not coupled to one end in the first direction of the return channel 432.

The supply channel 431 and the return channel 432 extend in the first direction. The supply channel 431 corresponds to the “second common channel” of the present disclosure. The return channel 432 corresponds to the “first common channel” of the present disclosure. The supply channel 431 and the return channel 432 have the same length (length in the first direction), the same width (length in the second direction), and the same height (length in the third direction).

A supply opening 431x and a return opening 432x are positioned on the same side with respect to individual channels 420 in the first direction. The supply opening 431x and the return opening 432x are arranged in the second direction.

The individual channels 420 are arranged in a row in the first direction. The individual channels 420 are positioned between the supply channel 431 and the return channel 432 in the second direction. Each individual channel 420 includes one nozzle 21, one pressure chamber 22, two outflow channels (first outflow channel 424a and second outflow channel 424b), and one inflow channel 424c.

The nozzles 21 are positioned immediately below the pressure chambers 22.

The inflow channel 424c has one end connected to one end in the second direction of the pressure chamber 22 and the other end (inlet 420c of the individual channel 420) connected to the supply channel 431. The supply channel 431 communicates with each pressure chamber 22 via the inflow channel 424c.

The first outflow channel 424a has one end connected to the other end in the second direction of the pressure chamber 22 and the other end (outlet 420a of the individual channel 420) connected to the return channel 432. The second outflow channel 424b has one end connected to the other end in the second direction of the pressure chamber 22 and the other end (outlet 420b of the individual channel 420) connected to the return channel 432. The return channel 432 communicates with each pressure chamber 22 via the first outflow channel 424a and the second outflow channel 424b.

The first outflow channel 424a corresponds to the “first communicating channel” of the present disclosure, and the second outflow channel 424b corresponds to the “second communicating channel” of the present disclosure, and the inflow channel 424c corresponds to the “third communicating channel” of the present disclosure. The outlet 420a is a connection opening between the return channel 432 and the first outflow channel 424a. The position of the outlet 420a corresponds to the “first connection position” of the present disclosure. The outlet 420b is a connection opening between the return channel 432 and the second outflow channel 424b. The position of the outlet 420b corresponds to the “second connection position” of the present disclosure. The inlet 420c is a connection opening between the supply channel 431 and the inflow channel 424c. The position of the inlet 420c corresponds to the “third connection position” of the present disclosure.

In this embodiment, the outflow channels 424a and 424b and the inflow channel 424c extend in the second direction. The outflow channels 424a and 424b and the inflow channel 424c are arranged in the first direction at regular intervals. In the first direction, the inlet 420c is placed at a center position between the outlet 420a and the outlet 420b. Namely, in the first direction, a midpoint between the position of the outlet 420a (first connection position) and the position of the outlet 420b (second connection position) is in a range of the position of the inlet 420c (third connection position).

As described above, although the channel configuration in the third embodiment is different from that in the first embodiment, the effects similar to the first embodiment can be obtained by satisfying the condition similar to the first embodiment (the condition in which the midpoint between the position of the outlet 420a (first connection position) and the position of the outlet 420b (second connection position) is in a range of the position of the inlet 420c (third connection position) in the first direction).

### Modified Example

The embodiments of the present disclosure are explained above. The present disclosure, however, is not limited to the above embodiments. Various changes or modifications in design may be made without departing from the claims.

The second embodiment (FIG. 5) may adopt a configuration, in which the position of the inlet 220a is coincident with the position of the inlet 220b in the first direction but the position of the inlet 220a is not coincident with the position of the inlet 220b in the second direction (i.e., the inlets 220a and 220b are arranged in the second direction) and a configuration, in which the position of the inlet 220a is coincident with the position of the inlet 220b in the first direction but the position of the inlet 220a is not coincident with the position of the inlet 220b in the third direction (i.e., the inlets 220a and 220b are arranged in the third direction).

The first common channel and the second common channel may have different widths (lengths in the second direction) and different heights (lengths in the third direction).

In the third embodiment, the inflow channels 324a and 324b are curved. Instead of curving the inflow channels 324a and 324b, the outflow channel 24c may be curved. In this case, it is possible to efficiently increase the resistance of the outflow channel 24c. This makes the flow rate in the outflow channel 24c high, thus discharging air from the individual channel 320 smoothly.

The filter may be provided for the return channel No filter may be provided for the supply channel

No damper may be provided for the first and second common channels.

The position of each nozzle is not limited to the center portion in a longitudinal direction of the coupling portion. Each nozzle may be positioned in any position in the longitudinal direction of the coupling portion (e.g., one end or the other end in the longitudinal direction of the coupling portion).

The number of nozzles belonging to each individual channel is one in the above embodiment. The number of nozzles belonging to each individual channel may be two or more.

The liquid discharge head is not limited to the line-type head. The liquid discharge head may be a serial type head in which liquid is discharged from nozzles on a medium (an object to which liquid is to be discharged) during its movement in a scanning direction parallel to the sheet width direction.

The medium is not limited to the sheet or paper, and may be a cloth, a substrate, and the like.

The liquid discharged from the nozzles is not limited to the ink, and may be any liquid (e.g., a treatment liquid that agglutinates or precipitates constituents of ink).

The present disclosure is applicable to facsimiles, copy machines, multifunction peripherals, and the like without limited to printers. The present disclosure is also applicable to a liquid discharge apparatus used for any other application than the image recording (e.g., a liquid discharge apparatus that forms an electroconductive pattern by discharging an electroconductive liquid on a substrate).

What is claimed is:

1. A liquid discharge head, comprising:
a plurality of individual channels arranged in a first direction; and
a first common channel and a second common channel extending in the first direction,
wherein an opening of the first common channel and an opening of the second common channel are arranged at the same side with respect to the individual channels in the first direction,
each of the individual channels includes:
a first communicating channel and a second communicating channel communicating with the first common channel; and
a third communicating channel communicating with the second common channel, and
a midpoint in the first direction between a first connection position where the first common channel is connected to the first communicating channel and a second connection position where the first common channel is connected to the second communicating channel is positioned in a range of a third connection position where the second common channel is connected to the third communicating channel

2. The liquid discharge head according to claim 1, wherein the first connection position is coincident with the second connection position in the first direction.

3. The liquid discharge head according to claim 2, wherein the first connection position is coincident with the second connection position in a second direction that is a width direction of the first common channel and the second common channel

4. The liquid discharge head according to claim 3, wherein the first connection position is coincident with the second connection position in a third direction that is a height direction of the first common channel and the second common channel

5. The liquid discharge head according to claim 3,
wherein the first common channel and the second common channel overlap with each other in a third direction that is a height direction of the first common channel and the second common channel,
a length in the second direction of the first common channel is identical to a length in the second direction of the second common channel,
a length in the third direction of the first common channel is identical to a length in the third direction of the second common channel, and
the third connection position is coincident with the first connection position and the second connection position in the second direction.

6. The liquid discharge head according to claim 1, wherein at least any of the first communicating channel, the second communicating channel, and the third communicating channel is a curved channel, which has a curved portion extending along a plane parallel to the first direction and a second direction and curving in the plane, the second direction being a width direction of the first common channel and the second common channel.

7. The liquid discharge head according to claim 6,
wherein each of the individual channels includes a nozzle and a pressure chamber communicating with the nozzle and the curved channel, and
the curved channel is disposed in an area of the pressure chamber in the second direction.
